(19) United States
(12) Patent Application Publication
(10) Pub. No.: US 2011/0314527 A1
(43) Pub. Date: Dec. 22, 2011

(54) INTERNET PROTOCOL-BASED FILTERING DEVICE AND METHOD, AND LEGITIMATE USER IDENTIFYING DEVICE AND METHOD

(75) Inventors: Su Yong KIM, Daejeon (KR); Hyung Geun OH, Daejeon (KR)

(73) Assignee: ELECTRONICS AND TELECOMMUNICATIONS RESEARCH INSTITUTE, Daejeon (KR)

(21) Appl. No.: 13/104,658

(22) Filed: May 10, 2011

(30) Foreign Application Priority Data
Jun. 21, 2010 (KR) 10-2010-0058564

(51) Int. Cl. G06F 21/20

(52) U.S. Cl. 726/6; 726/13

(57) ABSTRACT

Provided are an Internet Protocol (IP)-based filtering device and method and a legitimate user identifying device and method. The IP-based filtering method includes receiving packets from terminals, determining whether the packets are transmitted based on legitimate user IPs, transmitting the packets to a web server when it is determined that the packets are transmitted based on the legitimate user IPs, and determining whether a capacity capable of processing the packets exists in the web server when it is determined that the received packets are not the packets transmitted based on the legitimate user IPs, and transmitting the packets to the web server when it is determined that the capacity exists in the web server, and blocking the packets when the capacity does not exist.

### CROSS-REFERENCE TO RELATED APPLICATION

This application claims the benefit of Korean Patent Application No. 10-2010-0058564, filed Jun. 21, 2010, the disclosure of which is hereby incorporated herein by reference in its entirety.

### BACKGROUND

1. Field of the Invention

The present invention relates to an Internet Protocol (IP)-based filtering device and method and a legitimate user identifying device and method, and more particularly, to an IP-based filtering device and method and a legitimate user identifying device and method, capable of blocking a denial of service (DoS) attack or a distributed DoS (DDoS) attack.

2. Discussion of Related Art

In general, a denial of service (DoS) or distributed DoS (DDoS) attack is an attack method of transmitting a large amount of malicious traffic from client terminals to a content providing server over a web network.

When the DoS or DDoS attack is successfully performed, all users of the corresponding site are unable to receive web service. This is because lost packets are uniformly distributed to all users' packets, not concentrated in a specified user's packets.

The related art has coped with the DoS or DDoS attack in such a way that countermeasure apparatuses are installed in front of the network of the web server to block packets suspected as attack packets. These conventional methods can deal with attacks that intend to exhaust resources of the web server of a targeted site. However, the conventional methods cannot effectively deal with attacks that intend to exhaust a network bandwidth itself of the targeted site.

### SUMMARY OF THE INVENTION

The present invention, therefore, solves the aforementioned problems associated with conventional devices by providing an Internet

Protocol (IP)-based filtering device and method and a legitimate user identifying device and method that are capable of identifying legitimate user terminals from among user terminals that attempt to access the site to provide continuous web service to legitimate users, when a DoS or DDoS attack occurs.

In addition, the present invention also solves the aforementioned problems associated with conventional devices by providing an IP-based filtering device and method and a legitimate user identifying device and method that are capable of preventing occurrence of service failures to legitimate users even when a DoS or DDoS attack that intend to exhaust the network bandwidth occurs.

According to one aspect of the present invention, an IP-based filtering method includes receiving packets from terminals; determining whether the packets are transmitted based on legitimate user IPs; transmitting the packets to a web server when it is determined that the packets are transmitted based on the legitimate user IPs, and determining whether a capacity capable of processing the packets exists in the web server when it is determined that the received packets are not the packets transmitted based on the legitimate user IPs; and transmitting the packets to the web server when it is determined that the capacity exists in the web server, and blocking the packets when the capacity does not exist.

According to another aspect of the present invention, a legitimate user identifying method includes determining whether terminals are legitimate user's terminals through a Completely Automated Public Turing test to tell Computers and Humans Apart (CAPTCHA) to determine whether a user of the terminal transmitting a packet to a web server is a human or a computer program; registering terminal IPs as legitimate user IPs or inaccessible IPs according to a result of the determination; and transmitting the packets transmitted from the terminals registered as the legitimate user IPs to the web server and blocking the packets transmitted from the terminals registered as the inaccessible IPs.

According to still another aspect of the present invention, an IP-based filtering device includes a packet receiver for receiving packets from terminals; a determination controller for determining whether the packets are transmitted based on legitimate user IPs and determining whether a capacity capable of processing the packets exists in a web server when the packets are not the packets transmitted based on the legitimate user IPs; and a packet transmitter for transmitting the packets to the web server under control of the determination controller when the determination controller determines that the packets are transmitted based on the legitimate user IPs or that the capacity exists in the web server.

According to yet another aspect of the present invention, a legitimate user identifying device includes a legitimate user determiner for determining whether a terminal transmitting a packet to a web server is a legitimate user's terminal; a registration controller for registering terminal IPs as legitimate user IPs or inaccessible IPs according to a result of the determination of the legitimate user determining part; and a packet transmitter for transmitting the packets transmitted from the terminals registered as the legitimate user IPs to the web server and blocking the packets transmitted from the terminals registered as the inaccessible IPs.

### BRIEF DESCRIPTION OF THE DRAWINGS

The above and other features of the present invention will be described in reference to certain exemplary embodiments thereof with reference to the attached drawings in which:

FIG. 1 is a view showing a system for dealing with DDoS attacks using an IP-based filtering device and a legitimate user identifying device in accordance with an exemplary embodiment of the present invention;

FIG. 2 is a block diagram of an IP-based filtering device in accordance with an exemplary embodiment of the present invention;

FIG. 3 is a block diagram of a legitimate user identifying device in accordance with an exemplary embodiment of the present invention;

FIG. 4 is a flowchart for explaining an IP-based filtering method in accordance with an exemplary embodiment of the present invention; and

FIG. 5 is a flowchart for explaining a legitimate user identifying method in accordance with an exemplary embodiment of the present invention.

### DETAILED DESCRIPTION OF EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

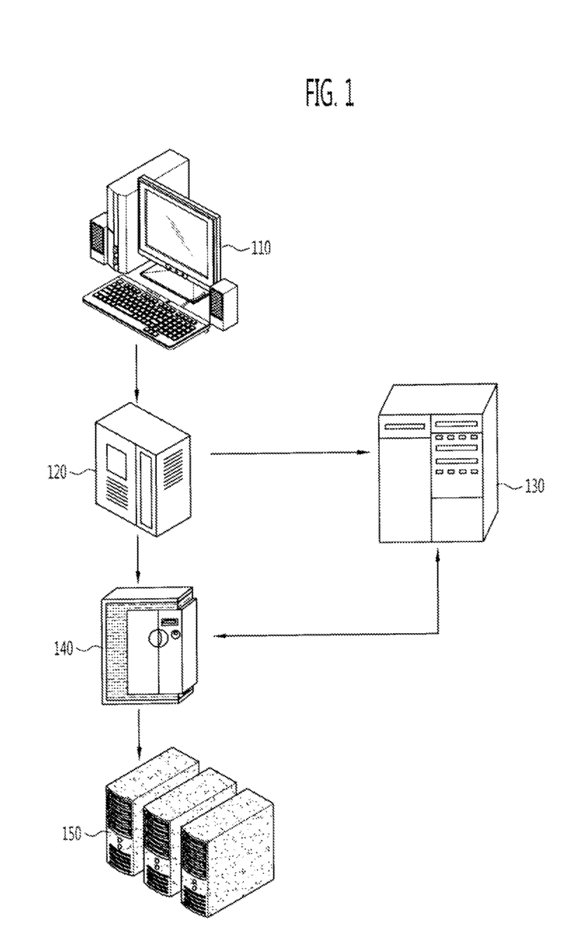

FIG. 1 is a view showing a system for dealing with DDoS attacks using an Internet Protocol (IP)-based filtering device and a legitimate user identifying device in accordance with an exemplary embodiment of the present invention.

An Internet service provider (ISP) server 120 transmits packets transmitted from terminals 110 to a web server 150 via an IP-based filtering device 130, rather than directly transmitting the packets to the web server 150, when it is determined that a DDoS attack on the web site provided by the web server 150 occurs.

The IP-based filtering device 130 receives all packets transmitted to the web server 150 to check the packets. More specifically, the IP-based filtering device 130 checks whether the received packets are transmitted based on legitimate user IPs using legitimate user IP information stored in a database. As a result of the checking, when it is determined that the packets are transmitted based on the legitimate user IPs, the IP-based filtering device 130 transmits the packets to the legitimate user identifying device 140. In contrast, when it is determined that the packets arc not the packets transmitted based on the legitimate user IP, the IP-based filtering device 130 determines whether the web server 150 or the legitimate user identifying device 140 has a capacity capable of processing the packets.

As a result of the determination, when it is determined that the web server 150 or the legitimate user identifying device 140 has the capacity capable of processing the packets, the IP-based filtering device 130 transmits the packets to the legitimate user identifying device 140. In contrast, when it is determined that the web server 150 or the legitimate user identifying device 140 does not have the capacity capable of processing the packets, the IP-based filtering device 130 blocks the packets. That is, the IP-based filtering device 130 prevents introduction of the packets exceeding a processable capacity.

The legitimate user identifying device 140 receives packets from the IP-based filtering device 130 to determine whether the terminals 110 that have transmitted packets are legitimate user's terminals. As a result of the determination, when it is determined that the terminals 110 are the legitimate user's terminals, the legitimate user identifying device 140 registers IPs of the terminals 110 as legitimate user IPs. In contrast, when it is determined that the terminals 110 are not the legitimate user's terminals, the device 140 registers the user IPs as inaccessible IPs. In order to determine whether the terminals 110 that have transmitted the packets are legitimate user's terminals, the legitimate user identifying device 140 may use a Completely Automated Public Turing test to tell Computers and Humans Apart (CAPTCHA) for determining whether a user of each terminal 110 is a human or each terminal 110 automatically transmits the packet under control of a computer program. The CAPTCHA uses various methods such as a method of providing an intentionally twisted figure that can be discriminated by a human but not by a computer and inquiring a content shown in the figure, and so on.

On the basis of the determination of the legitimate user's terminal, the legitimate user identifying device 140 registers the IP of the terminal 110 as the legitimate user IP or the inaccessible IP. Therefore, the IP-based filtering device 130 passes or blocks the packets introduced from the terminals 110 according to information about the registered legitimate user IPs and the inaccessible IPs. As a result, according to the embodiment, since the inaccessible IPs are filtered by the legitimate user identifying device 140 to be registered and stored in the IP-based filtering device 130, the IP-based filtering device 130 can rapidly and accurately filter malicious packets when checking the packets.

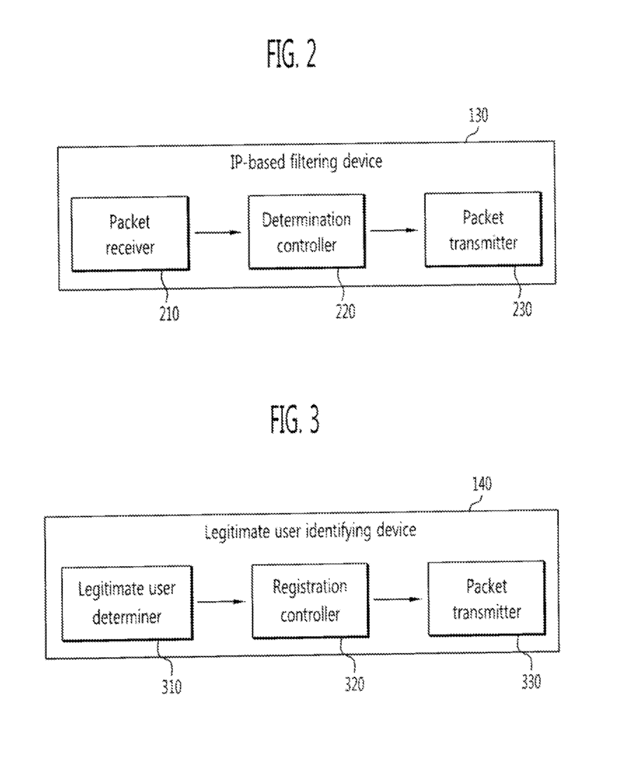

FIG. 2 is a block diagram of an IP-based filtering device in accordance with an exemplary embodiment of the present invention. Constitution of the IP-based filtering device in accordance with an exemplary embodiment of the present invention will be described with reference to FIG. 2.

As shown in FIG. 2, the IP-based filtering device 130 in accordance with an exemplary embodiment of the present invention includes a packet receiver 210, a determination controller 220, and a packet transmitter 230.

The packet receiver 210 receives packets transmitted from terminals to be transmitted to the web server.

The determination controller 220 determines whether the packets are transmitted based on the legitimate user IPs. When the received packets are not the packets transmitted from the legitimate user IPs, the determination controller 220 determines whether the capacity capable of processing the packets exists in the web server 150. Here, the determination controller 220 may be configured to determine whether the packets are transmitted based on the legitimate user IPs with reference to the legitimate user IP information stored in a database (not shown).

The packet transmitter 230 transmits the packets to the web server under control of the determination controller 220 when the determination controller 220 determines that the packets arc transmitted based on the legitimate user IPs or the capacity capable of processing the packets exists in the web server.

FIG. 3 is a block diagram of a legitimate user identifying device in accordance with an exemplary embodiment of the present invention. Constitution of the legitimate user identifying device in accordance with an exemplary embodiment of the present invention will be described with reference to FIG. 3.

As shown in FIG. 3, the legitimate user identifying device 140 in accordance with an exemplary embodiment of the present invention includes a legitimate user determiner 310, a registration controller 320, and a packet transmitter 330.

The legitimate user determiner 310 determines whether the terminal transmitting the packet to the web server is a legitimate user's terminal. Here, the legitimate user determiner 310 can determine whether the terminal is a legitimate user's terminal through the CAPTCHA.

As a result of the determination of the legitimate user determiner 310, when it is determined that the terminal is the legitimate user's terminal, the registration controller 320 registers the terminal IP as a legitimate user IP. In contrast, when the terminal is not the legitimate user's terminal, the registration controller 320 registers the terminal IP as an inaccessible IP. Further, the registration controller 320 can control the IP-based filtering device 130 to register the terminal IP as the legitimate user IP or the inaccessible IP. That is, the registration controller 320 can control the IP-based filtering device 130 to register the terminal IP as the legitimate user IP when the terminal is the legitimate user's terminal, and can control the IP-based filtering device 130 to register the terminal IP as the inaccessible IP when the terminal is not the legitimate user's terminal.

The packet transmitter 330 transmits the packets received from the legitimate user's terminals to the web server. Meanwhile, the packet transmitter 330 blocks the packets received based on the inaccessible IP, thereby transmitting no packets to the web server.

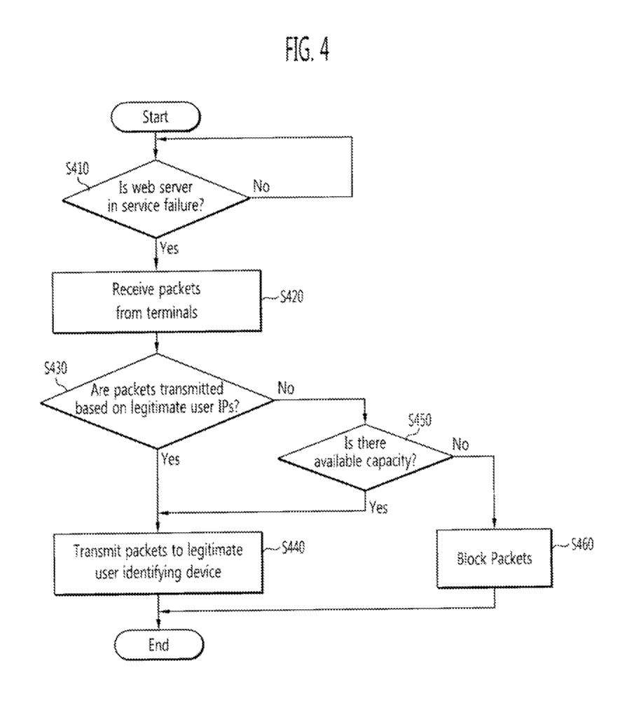

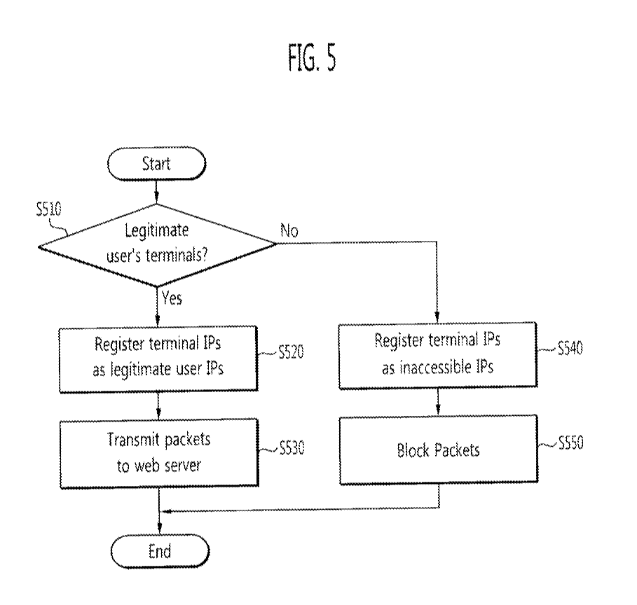

FIG. 4 is a flowchart for explaining an IP-based filtering method in accordance with an exemplary embodiment of the present invention.

In operation S410, it is determined whether a web server is in a service failure. At this time, in operation S410, it is determined whether a DDoS attack is made on the web site provided by the web server, so that the web server is in a service failure. In addition, the ISP server may be configured to detect the service failure or the DDoS attack.

In operation S420, when the web server is determined to be in a service failure as a result of the determination in operation S410, the packets transmitted from the terminals to the web server are received. Here, the packets may be transmitted and received under control of the ISP server.

Next, in operation S430, it is determined whether the packets are transmitted based on the legitimate user IPs with reference to the legitimate user IP information stored in the database.

In operation S440, as a result of the determination, when the packets are transmitted based on the legitimate user IPs, the packets are transmitted to the web server and delivered to the legitimate user identifying device. Meanwhile, the legitimate user identifying device determines whether the terminal is the legitimate user's terminal, and registers the terminal IP as the legitimate user IP when the terminal is the legitimate user's terminal and registers the terminal IP as the inaccessible IP when the terminal is not the legitimate user's terminal.

In operation S450, as a result of the determination in operation S430, when the packets are not the packets transmitted based on the legitimate user IPs, it is determined whether the capacity capable of processing the packets exists in the web server.

As a result of the determination in operation S450, when the capacity capable of processing the packets exists in the web server, the controller transmits the packets to the web server, or when the capacity does not exist, the controller blocks the packets (S460).

FIG. 5 is a flowchart for explaining a legitimate user identifying method in accordance with an exemplary embodiment of the present invention.

In operation S510, it is determined whether the terminal transmitting the packet to the web server is the legitimate user's terminal. At this time, in order to determine whether the user of the terminal is a human or a computer program, the CAPTCHA can be used to determine whether the terminal automatically transmits the packet according to the computer program.

In operation S520, when it is determined that the terminal is the legitimate user's terminal in operation S510, the controller registers the terminal IP as the legitimate user IP, and in operation S530, transmits the packet received from the terminal registered as the legitimate user IP to the web server. When it is determined that the terminal is not the legitimate user's terminal in operation S510, the controller registers the terminal IP as the inaccessible IP in operation S540, and blocks the packet transmitted from the terminal registered as the inaccessible IP in operation S550.

In addition, upon IP registration in operations S520 and S540, the terminal IPs are registered as the legitimate user IPs or the inaccessible IPs in the IP-based filtering device, so that the registered inaccessible IPs are stored, more rapidly and accurately filtering malicious packets upon packet checking of the IP-based filtering device.

The embodiments of the present invention as described above may be implemented through various methods. For example, the embodiments may be implemented using hardware, software or a combination thereof. When the embodiments are implemented using software, the embodiments may be implemented using software executed in at least one processor using various operation systems or platforms. In addition, the software may be written using arbitrary language among a plurality of appropriate programming languages, and may be compiled in a machine language or intermediate codes that can be executed in a framework or an imaginary machine.

Further, the present invention can be implemented by a computer-readable medium (for example, a computer memory, at least one floppy disc, a compact disc, an optical disc, a magnetic tape, a flash memory, etc.) on which at least one program is recorded to perform a method of implementing various embodiments of the present invention, when it is performed on least one computer or another processor.

As can be seen from the foregoing, it is possible to provide an IP-based filtering device and method and a legitimate user identifying device and method that are capable of identifying legitimate user terminals from user terminals that attempt to access the site to provide continuous web service to legitimate users, when a DoS or DDoS attack occurs, and preventing occurrence of service failures to legitimate users even when a DoS or DDoS attack that intends to exhaust the network bandwidth occurs.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. An internet protocol (IP)-based filtering method, comprising:
receiving packets from terminals;
determining whether the packets are transmitted based on legitimate user IPs;
transmitting the packets to a web server when it is determined that the packets are transmitted based on the legitimate user IP, and determining whether a capacity capable of processing the packets exists in the web server when it is determined that the received packets are not the packets transmitted based on the legitimate user IPs; and
transmitting the packets to the web server when it is determined that the capacity exists in the web server, and blocking the packets when the capacity does not exist.

2. The method according to claim 1, wherein determining whether the packets are transmitted based on the legitimate user IPs further includes determining whether the packets are transmitted based on the legitimate user IPs with reference to information about the legitimate user IPs stored in a database.

3. The method according to claim 1, wherein blocking the packets when the capacity does not exist further includes receiving the packets to a legitimate user identifying device for registering the terminal IPs as legitimate user IPs or inaccessible IPs according to whether the terminal is the legitimate user's terminal when it is determined that the capacity exists in the web server to transmit the packets to the web server, and blocking the packets when the capacity does not exist.

4. A legitimate user identifying method, comprising:
determining whether a terminal is a legitimate user's terminal through a Completely Automated Public Turing test to tell Computers and Humans Apart (CAPTCHA) to determine whether a user of the terminal transmitting the packet to a web server is a human or a computer program;
registering the terminal IP as a legitimate user IP or an inaccessible IP according to a result of the determination; and
transmitting the packets transmitted from the terminals registered as the legitimate user IPs to the web server and blocking the packets transmitted from the terminals registered as the inaccessible IPs.

5. The method according to claim 4, further comprising registering the terminal IP as the legitimate user IP or the inaccessible IP in an IP-based filtering device for filtering the packets according to whether the packets are transmitted from the legitimate user IP.

6. An IP-based filtering device comprising:
a packet receiver for receiving packets from terminals;
a determination controller for determining whether the packets are transmitted based on legitimate user IPs and determining whether a capacity capable of processing the packets exists in a web server when the packets are not the packets transmitted based on the legitimate user IPs; and
a packet transmitter for transmitting the packets to the web server under control of the determination controller when the determination controller determines that the packets are transmitted based on the legitimate user IPs or that the capacity exists in the web server.

7. The IP-based filtering device according to claim 6, wherein the determination controller blocks the packets when it is determined that the capacity does not exist.

8. A legitimate user identifying device comprising:
a legitimate user determiner for determining whether terminals transmitting packets to a web server are legitimate user's terminals;
a registration controller for registering the terminal IPs as legitimate user IPs or inaccessible IPs according to a result of the determination of the legitimate user determiner; and
a packet transmitter for transmitting the packets transmitted from the terminals registered as the legitimate user IPs to the web server and blocking the packets transmitted from the terminals registered as the inaccessible IPs.

9. The legitimate user identifying device according to claim 8, wherein the packet transmitter blocks the packets when the registration controller registers the terminal IPs as the inaccessible IPs.

10. The legitimate user identifying device according to claim 8, wherein the registration controller registers the terminal IPs as the legitimate user IPs to an IP-based filtering device for filtering the packets according to whether the packets are transmitted based on the legitimate user IPs when the terminals are the legitimate user's terminals as a result of the determination of the legitimate user determiner through a CAPTCHA, and registers the terminal IPs as the inaccessible IPs to the IP-based filtering device when the terminals are not the legitimate user's terminals.

11. The legitimate user identifying device according to claim 8, wherein the legitimate user identifying device is disposed in front of the web server to receive packets transmitted to the web server.
